(19) United States
(12) Patent Application Publication
(10) Pub. No.: US 2011/0298302 A1
(43) Pub. Date: Dec. 8, 2011

(54) Toggling Method and Apparatus in Controllers for Home Appliances

(76) Inventor: Radu Pitigoi-Aron, San Jose, CA (US)

(21) Appl. No.: 13/114,718

(22) Filed: May 24, 2011

Related U.S. Application Data
(60) Provisional application No. 61/351,476, filed on Jun. 4, 2010.

(51) Int. Cl. H01H 9/00

(52) U.S. Cl. 307/125

(57) ABSTRACT

Disclosed is a toggle detection circuit for detecting occurrences of a single toggle event or a double toggle event. In embodiments, a double toggle event comprises at least two occurrences of a single toggle event within a given period of time. Suitable signaling can be asserted to indicate a single toggle event and a double toggle event. In embodiments, a power controller can provide different functions depending on whether a single toggle event has occurred or a double toggle event has occurred.

### CROSS REFERENCE TO RELATED APPLICATIONS

The present disclosure claims priority to U.S. Provisional App. No. 61/351,476 filed Jun. 4, 2010, and is incorporated herein by reference in its entirety for all purposes.

### BACKGROUND

The present invention relates to home appliances and in particular to controllers for use with home appliances.

Unless otherwise indicated herein, the approaches described in this section are not prior art to the claims in this application and are not admitted to be prior art by inclusion in this section.

The advancement of electronics technology has allowed the implementation of many useful, intelligent features in lighting fixtures and other home appliances (e.g., fans, heaters, consumer electronics such as televisions, game stations, and so on). Consider for example, intelligent light bulbs or light fixtures. Energy saving features such as full power and intermediate power operation can provide various brightness levels, allowing for dimmed operation when desired. Timing features can be provided to automatically turn off the device after a period of time; in the case of lighting devices, a timer can incrementally dim the light over a period of time in one or more increments before turning it off.

In order to control such features, the conventional solution employs a dedicated controller. For example, it is known in the industry to employ a procedure for interpreting a short POWER TOGGLE as a logical command. For example, a POWER TOGGLE event (or occurrence) might be defined as toggling a switch from the ON position to the OFF position followed by a toggle action of the switch back to the ON position. Typically, the two toggle actions must occur within a given period of time, for example one second. A lighting unit may include a controller that can detect the occurrence of a POWER TOGGLE event of the light switch and respond accordingly. For example, the lighting unit may alternate between full brightness and 50% brightness each time the controller detects a POWER TOGGLE event from the light switch. As another example, the lighting unit may cycle through a range of brightness levels each time the controller detects a POWER TOGGLE event from the light switch.

However, this method generates only one type of event, namely a POWER TOGGLE event. Accordingly, only one function can be practically controlled; e.g., select a dimming level. More sophisticated functionality cannot be conveniently provided. For example, power control functions such as controlling dimming levels and setting a timer with different timing values cannot be easily provided with conventional toggling schemes.

Microcontroller-based controllers, double-channel switches, push-button units, and other sophisticated controllers can provide a comprehensive control capability. However, such controller systems are more suitable for new construction or during remodeling because their installation in an existing facility typically requires significant reconfiguration of the existing wiring. Most buildings, however, employ traditional single-pole-single-throw (SPST) toggle switches, which have an ON and an OFF state to respectively provide and interrupt power to the device, such as a light bulb, a fan, and so on. Accordingly, most buildings at best can provide single POWER TOGGLE event control functionality, and thus cannot benefit from additional power saving functions that may require more sophisticated controls.

These and other issues are addressed by embodiments of the present invention, individually and collectively.

### SUMMARY

In embodiments, a method for controlling a device based on the toggling of a power switch includes detecting the occurrence of a SINGLE TOGGLE event or the occurrence of a DOUBLE TOGGLE event. A SINGLE TOGGLE event may include two toggle actions performed on the power switch within a first period of time. A DOUBLE TOGGLE event may include two or more SINGLE TOGGLE events. In embodiments, the method may include asserting a first signal and a second signal depending on which toggle event occurs. The device may perform first and second actions depending on which toggle event occurs.

In an embodiment, a DOUBLE TOGGLE event may comprise a first SINGLE TOGGLE event separated in time from a second SINGLE TOGGLE event by a given period of time. The given period of time may be based on a counter.

In embodiments, an apparatus for sensing toggling in a power switch of an electric device may include means for detecting a toggle event of the power switch and timing means for indicating whether a first toggle event and a second event occur within a given amount of time, and means for asserting a signal indicating that one of the toggle events has occurred. The apparatus may include a power controller that functions differently depending on which toggle event has occurred.

In embodiments, an electric device may include an apparatus for detecting SINGLE TOGGLE events and DOUBLE TOGGLE events. The device may include a power controller to provide power to the device, and to perform a first power control function or a second power control function depending on the detected toggle event.

The present invention presents a way of adding a second distinct control signal to the system, without using any supplementary hardware or reconfiguring the already installed base. This is achieved by reliably sensing a relatively fast double POWER TOGGLING, giving the user the same perception as the double-click on the PC mouse.

The following detailed description and accompanying drawings provide a better understanding of the nature and advantages of the present invention.

### BRIEF DESCRIPTION OF THE DRAWINGS

FIG. 1 illustrates circuit configurations in accordance with the present invention

FIG. 1A illustrates the incorporation of a ground line in an embodiment of the present invention.

FIG. 2A represents a block diagram of a configuration of a circuit in accordance with the present invention.

FIG. 2B represents a block diagram of an alternate configuration of a circuit of the present invention.

FIG. 3 illustrates a state transition diagram showing states of a circuit in accordance with the present invention.

FIG. 4 is a circuit diagram illustrating an embodiment of the present invention.

FIG. 4A shows an alternate embodiment of the present invention.

FIGS. 5-7 show timing diagrams for switching scenarios.

FIG. 8 shows a sequence chart in accordance with embodiments of the present invention.

FIGS. 9 and 10 show truth tables to illustrate operation of the circuit shown in FIG. 4.

### DETAILED DESCRIPTION

Described herein is a toggling method and apparatus in controllers for home appliances.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

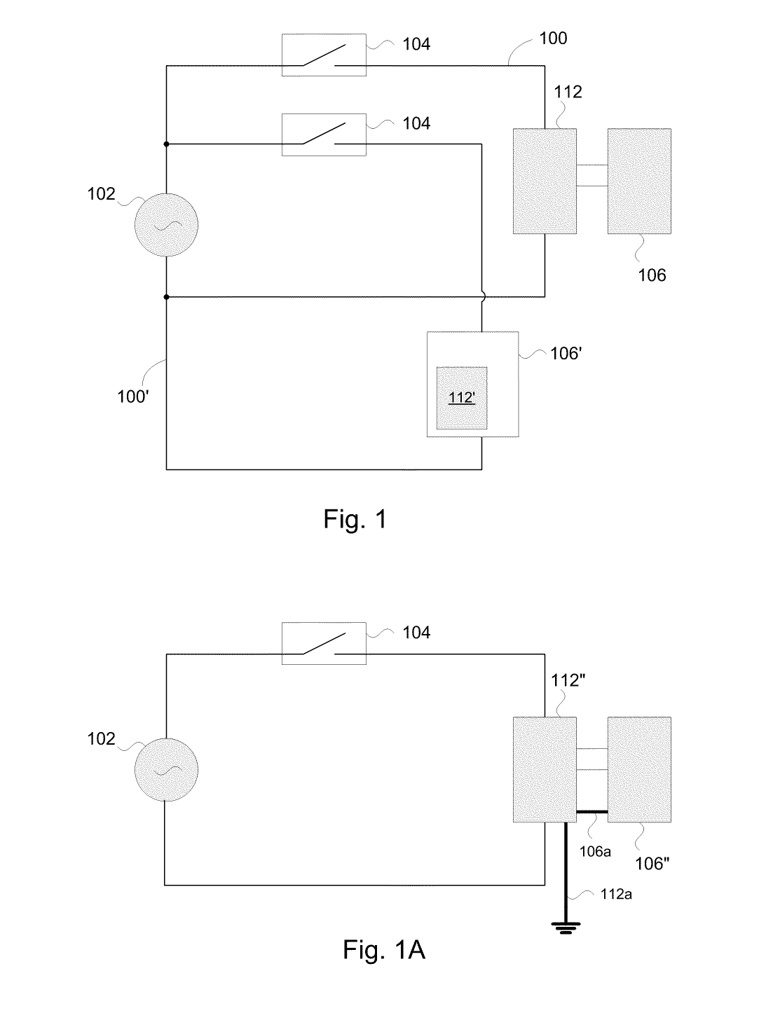

Referring to FIG. 1, a toggle detection circuit 112 in accordance with embodiments of the present invention is shown incorporated in a typical switched circuit 100. A power source 102 in the circuit 100 can be the typical the 120 V AC outlet found in a home. The circuit 100 typically includes a series-connected switch 104 to provide power or to interrupt power to a load 106. The switch 104 has an ON (closed) position and an OFF (open) position. FIG. 1 shows the switch 104 in the OFF position. In an embodiment, the switch 104 can be a single pole single throw (SPST) type of switch. Power terminals of the load 106 are connected on the “hot” side of the circuit 100 to receive power from the power source 102 and on the “neutral” side of the circuit to provide a return path for the electric current. For example, the load 106 can be a lighting system or a fan. In examples which follow, the load 106 may be shown as a light bulb in order to provide context to explain aspects of the present invention. It will be appreciated, however, that the load 106 can be any home appliance, consumer electronics, or other electrical equipment that is suitable for use with the present invention.

A toggle detection circuit 112 can be series-connected to the circuit 100 in the manner shown in FIG. 1. The load 106 can be connected to the toggle detection circuit 112. For example, suppose the load 106 is a light bulb. The toggle detection circuit 112 can be incorporated in a receptacle that the light bulb screws into. In accordance with the present invention, the toggle detection circuit 112 can control the delivery of power to the light bulb depending on how the switch 104 is toggled.

In embodiments, the toggle detection circuit can be incorporated in the load. FIG. 1 shows a second switched circuit 100′ having a load 106′. Here, the load 106′ incorporates a toggle detection circuit 112′. For example, the load 106′ can be a ceiling fan that incorporates the toggle detection circuit 112′. As another example, the load 106′ can be a “smart” light bulb that includes the toggle detection circuit 112′ within the base of the light bulb. It will be appreciated, however, that the load 106′ can be any home appliance, consumer electronics, or other electrical equipment that can incorporate the toggle detection circuit 112′ and is suitable for use with the present invention.

FIG. 1 shows a two-wire configuration comprising a hot wire and a neutral wire. However, it will be appreciated that embodiments of the present invention can be used in a three-wire configuration that includes a ground wire. Consider, for example, the three-wire configuration of FIG. 1A which includes a ground wire 112a. A load 106″ may include a ground wire 106a. A toggle detection circuit 112″ of the present invention may be configured with a ground wire 112a in order to provide a proper path to ground for the load 106″. The load 106″ can be any three-wire home appliance, consumer electronics, or other electrical equipment that is suitable for use with the present invention.

The following terminology will be used: A “toggle action” (or simply “toggle”) will be understood to refer to toggling a switch (e.g., 104) from a first switch position (e.g., the OFF position) to a second switch position (e.g., the ON position). A “toggle event” (a single toggle event) will be understood to refer to the flipping of a switch from the first position to the second position and then back to the first position within a given period of time. A “double toggle event” will be understood to refer to the occurrence of a first toggle event followed by a second toggle event within a given period of time. For example, a “toggle event” might be defined as flipping the switch from the ON position, to the OFF position, and back to the ON position within one half of a second. A “double toggle event” might be a first toggle event followed by a second toggle event one-half second later.

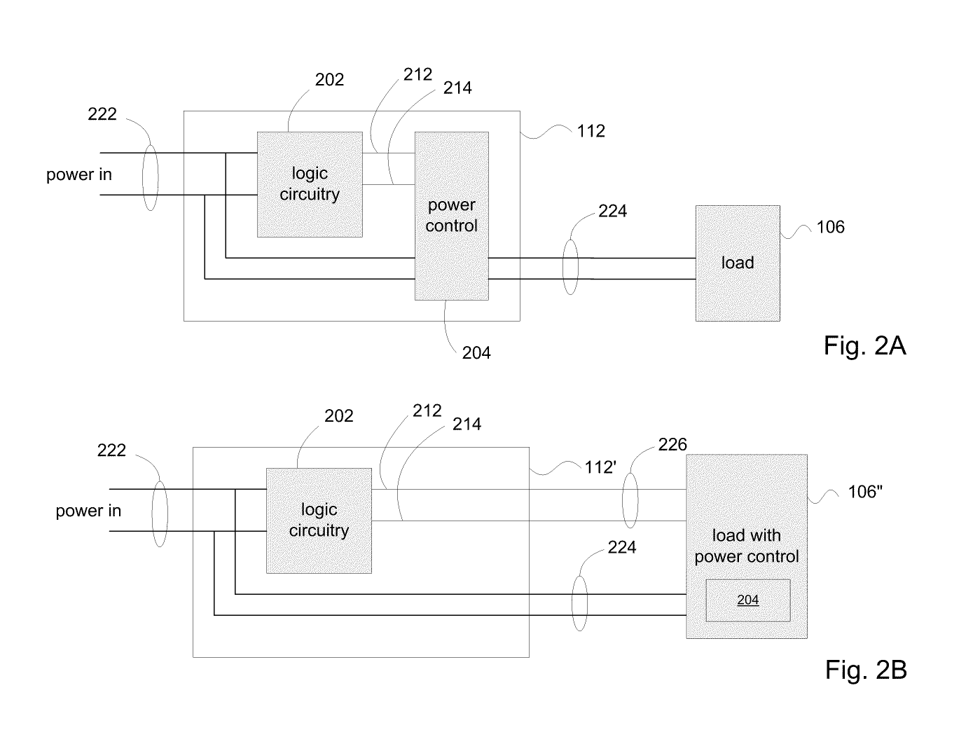

In embodiments, such as shown in FIG. 2A, the toggle detection circuit 112 may include logic circuit 202 and a power control circuit 204. The toggle detection circuit 112 can be configured to detect toggle actions of the switch 104 when it is connected in a circuit. For example, the power input lines 222 can be connected to the switch 104 in the manner shown in the circuit 100 of FIG. 1 so that when the switch is closed, power is delivered to the toggle detection circuit 112, and when the switch is opened, power to the toggle detection circuit is interrupted. In embodiments, the toggle detection circuit 112 can be configured to detect the occurrence of a single toggle event, or a double toggle event. The toggle detection circuit 112 can assert a signal on signal line 212 in response to the occurrence of a single toggle event. Similarly, the toggle detection circuit 112 can assert a signal on signal line 214 in response to the occurrence of a double toggle event. The signals asserted on respective signal lines 212 and 214 can be the same signal (e.g., a 100 mS pulse can be used for each signal line), or different signals can be used (e.g., one signal can be a square pulse, the other can be a triangular pulse), the signals can be sinusoidal waves, etc. It will be appreciated that any suitable signals can be used. In embodiments, a single line (e.g., 212) may transmit two different signals, one representing a single toggle event and another representing a double toggle event.

The signal lines 212, 214 and the power input lines 222 can feed into the power control circuit 204. The occurrence of a single toggle event can be indicated when the logic circuit 202 asserts a suitable signal on the single toggle signal line 212. Similarly, the occurrence of a double toggle event can be indicated when the logic circuit 202 asserts a suitable signal on the double toggle signal line 214. The power control circuit 204 can be configured to receive power from power input lines 222 and output the power on externally accessible output power lines 224. An external load (e.g., a light, or a fan) can then be connected to the toggle detection circuit 112 in the manner shown in circuit 100 of FIG. 1. The power control circuit 204 can be programmed for different power control functions to deliver power to the output power lines 224 in any of numerous ways depending on one or more sequences of occurrences of single toggle events and double toggle events that are detected on the single toggle signal line 212 and the double toggle signal line 214 in order.

As a specific example, suppose the power control circuit 204 provides an auto-dimming feature for a light fixture. The power control circuit 204 may implement an auto-dimming feature with the following power control functions: As a first function, the feature can be disabled or enabled. When enabled, the power control circuit 204 will automatically dim the light to a certain brightness. When disabled, the light is not automatically dimmed. As a second function, the brightness level can be programmed; e.g., 75% of full brightness, 50%, and 25%. For the first function, occurrences of single toggle events can be used to disable and enable the auto-dimming feature. The power control circuit 204 can monitor the single toggle signal line 212. Each time the logic circuit 202 asserts a signal on the single toggle signal line 212, the power control circuit 204 can alternate between enabling and disabling the auto-dimming feature.

As for the second function, both single toggle events and double toggle events can be used for setting the brightness level. A first double toggle event can signify to the power control circuit 204 that the brightness level should be set. For example, when the logic circuit 202 asserts a signal on the double toggle signal line 214, the power control circuit 204 may enter a brightness level setting mode and monitor the single toggle signal line 212 to look for occurrences of single toggle events. For each occurrence of a single toggle event, the brightness level setting can cycle through the 75%, 50%, and 25% of full brightness levels. A second double toggle event can signify the completion of setting the brightness value. The power control circuit 204 can exit the brightness level setting mode.

As another specific example, consider the control of a ceiling fan. The power control circuit 204 may implement a speed control feature with the following power control functions: As a first function, the speed of the fan may be controlled from slow, medium, and fast speeds. As a second function, an auto-shutoff feature that automatically turns off the fan can be enabled or disabled. Successive occurrences of single toggle events can cause the fan to cycle through the slow, medium, and fast fan speeds. Occurrences of double toggle events can alternate between enabling and disabling the auto-shutoff feature.

In some embodiments, the toggle detection circuit 112 may comprise the logic circuit component 202 absent the power control circuit 204. FIG. 2B illustrates an embodiment of such a configuration. The toggle detection circuit 112″ can provide the single toggle signal line 212 and the double toggle signal line 214 as externally accessed lines 226, in addition to the output power lines 224. The power control circuit 204 can be provided in a load 106″. The signal lines 212, 214 and the output power lines 224 can then be directly connected to the load 106″.

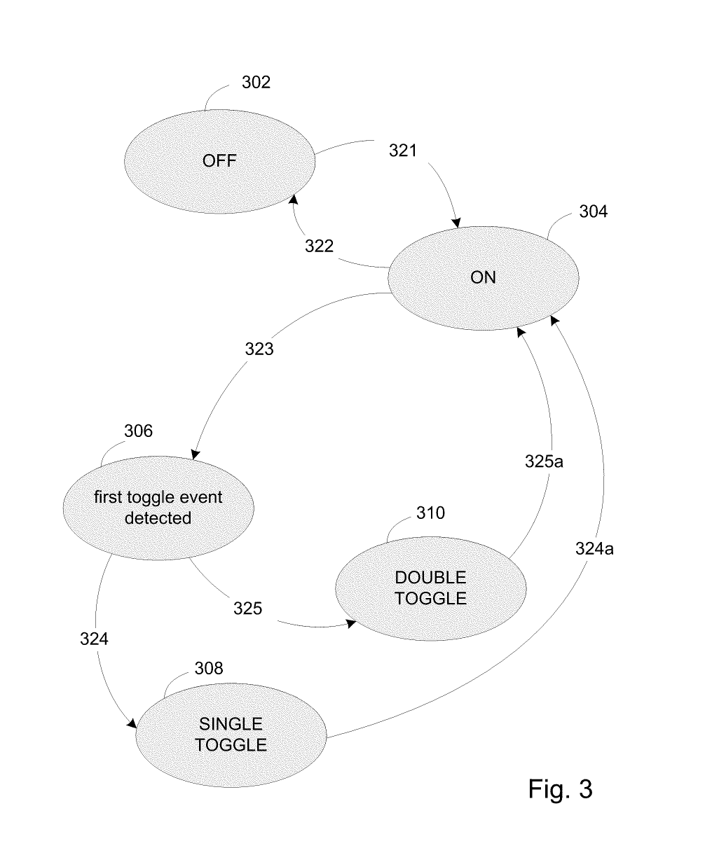

FIG. 3 represents a transition state diagram that illustrates various states of operation of the logic circuit 202 of the toggle detection circuit 112 in accordance with embodiments of the present invention. An OFF state 302 represents a situation where the toggle detection circuit 112 has no power. For example, the switch 104 is in the open position and no current flows through the circuit 100. The logic circuit 202 remains in the OFF state 302 so long as the switch 104 remains in the open position. An ON state 304 represents a situation where the switch 104 is in the closed position. A transition 321 from the OFF state to the ON state may occur, for example, when someone flips the switch 104 to the closed position. The logic circuit 202 remains in the ON state 304 so long as the switch 104 remains in the closed position. A transition 322 from the ON state to the OFF state may occur, for example, when someone flips the switch to the open position.

A first toggle event detected state 306 represents the occurrence of a toggle event. A transition 323 from the ON state 304 to the first toggle event detected state 306 may occur, for example, when someone flips the switch 104 (initially in the closed position) to the open position and then back to the closed position. In embodiments, the toggle event is performed within a given period of time. A transition 324 to a SINGLE TOGGLE state 308 may occur when an amount of time has passed and no additional toggle event has occurred, thus signifying the occurrence of a SINGLE TOGGLE event. The single toggle signal line 212 can be asserted when the logic circuit 202 enters the SINGLE TOGGLE state 308. A transition 324a to the ON state 304 occurs soon after the logic circuit 202 enters the SINGLE TOGGLE state 308.

Returning to the first toggle event detected state 306, a transition 325 to a DOUBLE TOGGLE state 310 may occur, for example, if another toggle event occurs. In embodiments, if another toggle event occurs within a given amount of time after the logic circuit 202 enters the SINGLE TOGGLE state 308, then the transition 325 to the DOUBLE TOGGLE state 310 may occur, thus signifying the occurrence of a DOUBLE TOGGLE event. The double toggle signal line 214 can be asserted when the logic circuit 202 enters the DOUBLE TOGGLE state 310. A transition 325a to the ON state 304 occurs soon after the logic circuit 202 enters the DOUBLE TOGGLE state 310.

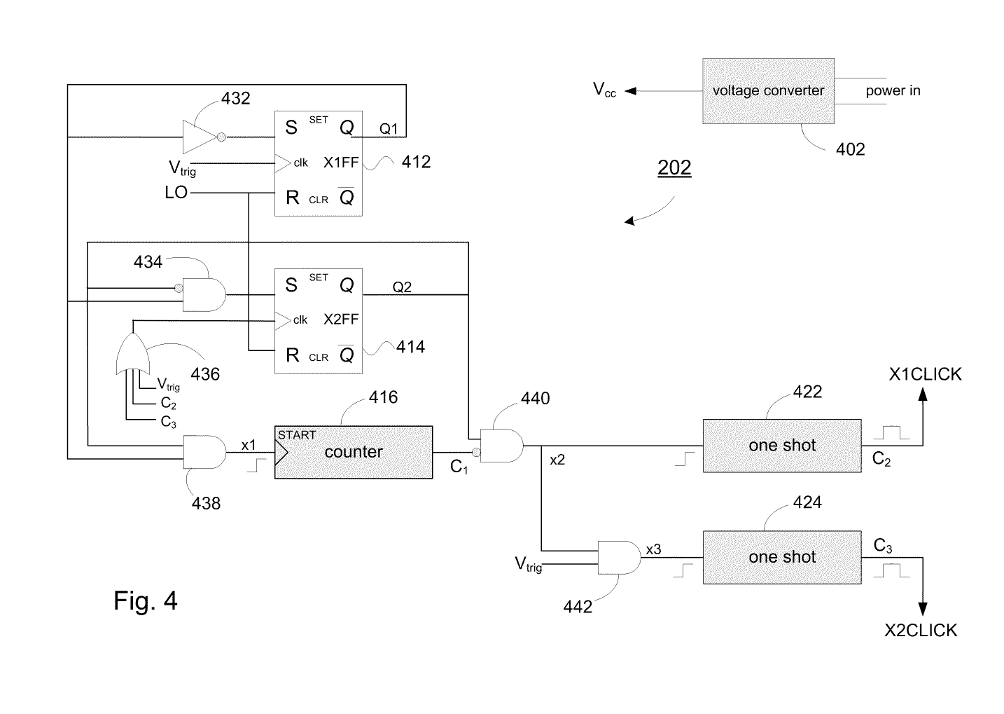

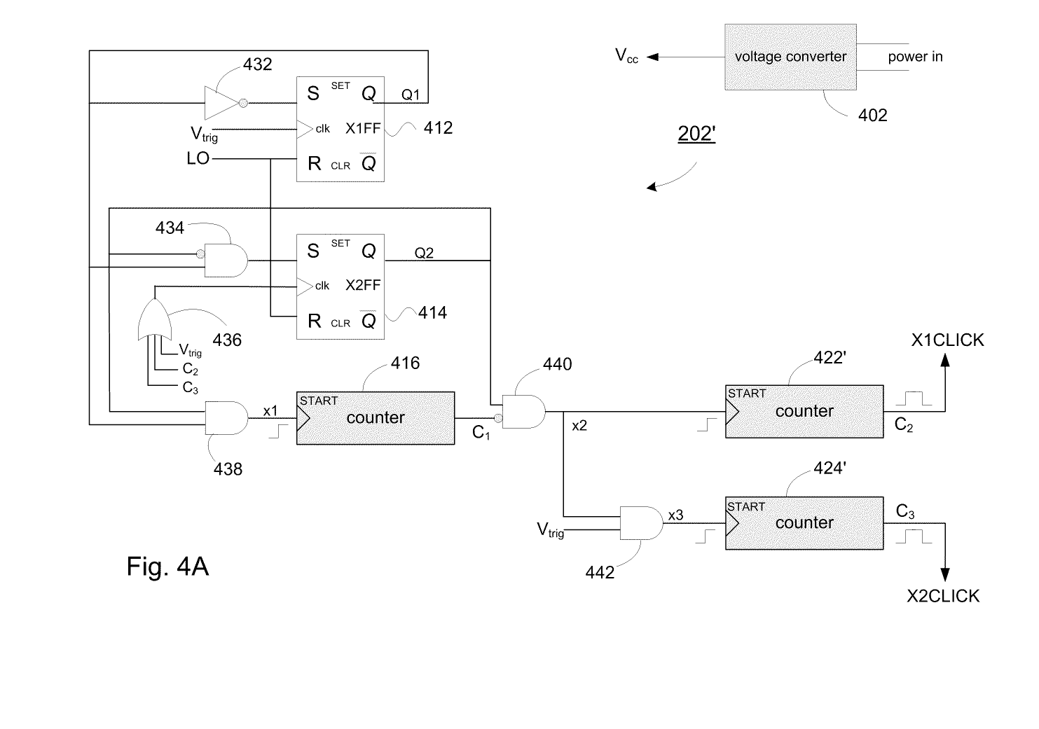

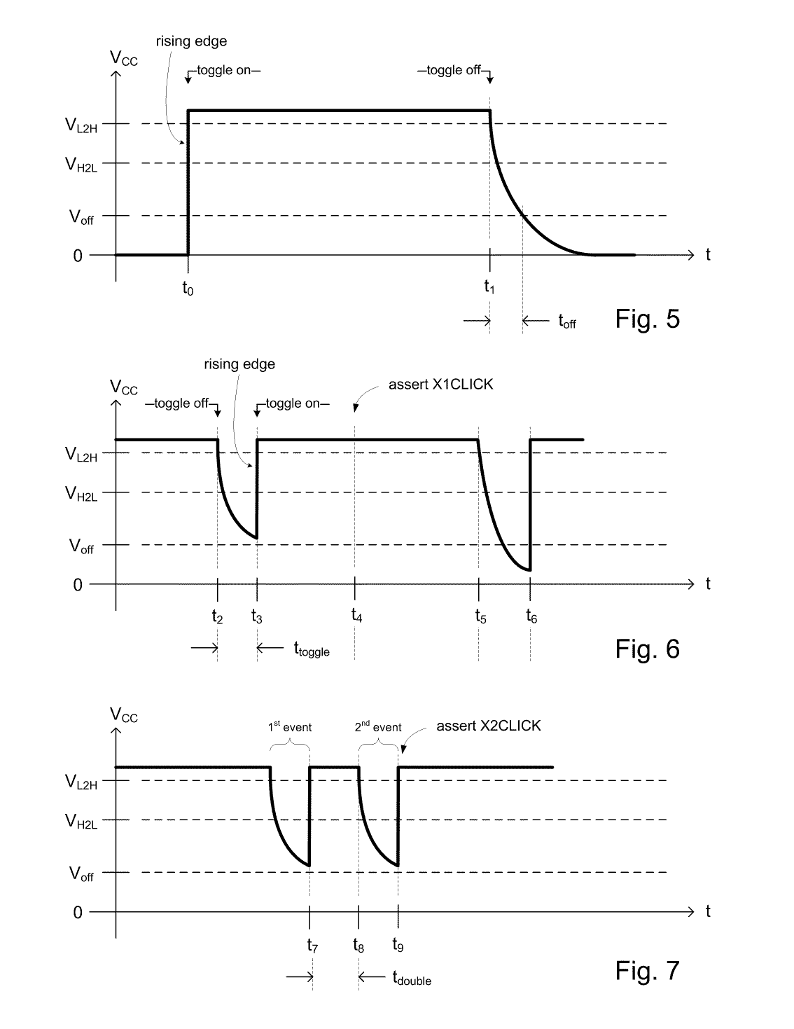

As shown in FIG. 4, an illustrative embodiment of the logic circuit 202 may include several digital devices. A voltage converter 402 can convert the incoming power (e.g., 120V AC) into a suitable DC voltage level V_{cc}. The digital devices can be powered by the voltage level V_{cc} which is output by the voltage converter 402. Digital devices in general are characterized by a range of V_{cc} levels within which the devices will maintain operational in one manner or another. Referring for a moment to the timing chart of FIG. 5, several levels for V_{cc} are shown. A voltage level V_{OFF} designates a minimum level below which the devices will not operate; for example, a typical value of V_{OFF} is 2.5V. The devices can be said to be in a “power off” condition when V_{cc}<V_{OFF}, no switching occurs and logic states are not retained.

The voltage level V_{L2H} designates the level above which V_{cc} must rise in order to turn on the device; for example, a typical value of V_{L2H} is 11.6V. This state of operation can be referred to as the “power on” condition. All of the switching logic is active and the device performs at its full capacity. After the device turns on, the device will continue to operate in the ON state so long as V_{cc} remains above a voltage level V_{H2L}; a typical value of V_{H2L} is 7.5V.

The voltage level V_{H2L} defines a range of V_{cc} between V_{H2L} and V_{OFF} within which some devices operate in a restricted mode. For example, the flip flops 412, 414 shown in FIG. 4 can retain their logic states when V_{cc} is in this range. However, further switching will not occur. This state of operation can be referred to as the “power save” condition. Thus, when V_{cc} falls below V_{H2L}, the switching logic ceases. However, there is enough energy to retain the logic state. If V_{cc} continues to decrease and falls below V_{OFF}, then the all of the devices become de-energized and effectively are turned off. If, on the other hand the V_{cc} level rises above V_{H2L}, then the device resumes operation, and logic states are retained.

FIG. 5 shows an additional characteristic of the digital devices that comprise the logic circuit 202. Assume that the devices are operating in a power on condition and assume that at some time t₁ the power is removed. The V_{cc} level will fall to 0V over a period of time. In embodiments, a time t_{OFF} designates the time that V_{cc} falls from V_{L2H} to V_{OFF} (the turn off time). For example, when the switch 104 is toggled to the open position, the logic circuit 202 in the toggle detection circuit 112 will turn off in a period of time t_{OFF}. The turn off time t_{off} represents the decay time of V_{cc} and is dependent on the specific components used to build the logic circuit 202.

Returning to FIG. 4, the logic circuit 202 may include flip flops 412, 414. In an embodiment, the flip flops are S-R flip flops, having an output Q that is set when inputs S/R are set to 1/0 and reset when inputs S/R are set to 0/1. The flip flops 412, 414 store state information used to determine whether a single toggle event or a double toggle event has occurred. The flip flops 412, 414 retain their state in the power save condition.

In an embodiment, the turn off time t_{off} of the logic circuit 202 serves as one timing source to determine the occurrence of a single toggle event or a double toggle event. A counter 416 can serve as another timing source to determine whether a single toggle event or a double toggle event has occurred. The counter 416 resets in the power save condition.

Monostable multivibrator circuits 422, 424 (one shots) can be provided to respectively assert an X1CLICK signal C₂ to indicate the occurrence of a single toggle event and an X2CLICK signal C₃ to indicate the occurrence of a double toggle event. Supporting logic elements 432-440 interconnect the main logic and will be explained as needed in the discussions which follow.

In embodiments, the devices can be edge-triggered devices, and in particular edge-triggered on the rising edge of the trigger signal. As will be explained below, a trigger signal V_{trig} can be derived from V_{cc}. Flip flops 412, 414 can be triggered by applying the trigger signal V_{trig} to their clock inputs. The counter 416 begins counting when it is triggered on the rising edge of the signal xl that is output by AND gate 438. The counter 416 outputs a count signal C₁ that is initially at the reset level (e.g., LO). The count signal C₁ goes HI when it is counting. When the counter 416 reaches the final count, the counter stops and the count signal C₁ goes LO and remains LO until another rising edge appears at x1 to initiate another counting cycle. As will be explained below, the time between the count signal C₁ going LO to HI and then back to LO can serve as a timing source for determining whether a single toggle event or a double toggle event ahs occurred.

In embodiments, the one shots 422, 424 can be designed to output a pulse of a given pulse width to serve as the signals C₂, C₃. The one shots 422, 424 can be triggered on the rising edge of respective signals x2, x3. FIG. 4A shows an embodiment of a logic circuit 202′ that uses counters 422′, 424′ in place of the one shots 422, 424. The counters 422a, 424a can also be triggered by respective signals x2, x3. The signals C₂, C₃ go HI when their respective counters 422a, 424a are counting, and then reset to LO when the final count is reached.

FIGS. 1 and 5-7 illustrate timing charts for V_{cc} during different switching operations of the switch 104 in circuit 100 and how each operation affects the logic circuit 202. FIG. 5 illustrates a simple ON-OFF scenario whereby a user toggles on the switch 104 (closes the switch) at time t₀. The rise in V_{cc} at time t₀ constitutes a rising edge. The logic circuit 202 is turned on when V_{cc} rises above V_{L2H}. At a time t₁, the user toggles off the switch 104 (opens the switch). V_{cc} falls below V_{OFF} in a period of time t_{off}, and reaches 0V shortly after.

FIG. 6 illustrates the timing for a single toggle event. Suppose, the switch 104 is already in the ON position. At time t₂, the user flips the switch 104 to the OFF position and at time t₃ flips the switch back to the ON position. If the toggle time t_{toggle} is less than t_{off}, then the logic circuit 202 can retain its state information when V_{cc} is restored to V_{L2H} at time t₃. After another period of time (t_{double}, see FIG. 7) has passed, then at time t₄ the X1CLICK signal C₂ can be asserted to indicate that a single toggle event has occurred; i.e., when the period of time t₄-t₃>t_{double}.

If, on the other hand, the toggle time t_{toggle} is greater than t_{off}, then the logic circuit 202 will have de-energized and any stored state information will be lost. For example, at time t₅ the switch was toggled off and then back on at time t₆. However, since the toggle time t₆-t₅ was greater than t_{off}, V_{cc} would have fallen below V_{OFF} causing the logic circuit 202 to de-energize and reset when V_{cc} is restored to V_{L2H} at time t₆, and the signal C₂ would not have been asserted.

FIG. 7 illustrates the timing for a double toggle event. The figure shows two toggle events. If the first toggle event and second toggle event occur within a period of time t_{double}, then the X2CLICK signal C₃ will be asserted. In an embodiment, the period of time t_{double} is measured between when the switch 104 was toggled on (at t₇) in the first toggle event and when the switch is toggled off in the second toggle event (at t₈). If the switch 104 is toggled back on (at t₉) before a period of time t_{off} has elapsed (i.e. t₉-t₈<t_{off}), then a toggle event will have occurred and more particularly a second toggle event will have been deemed to have occurred.

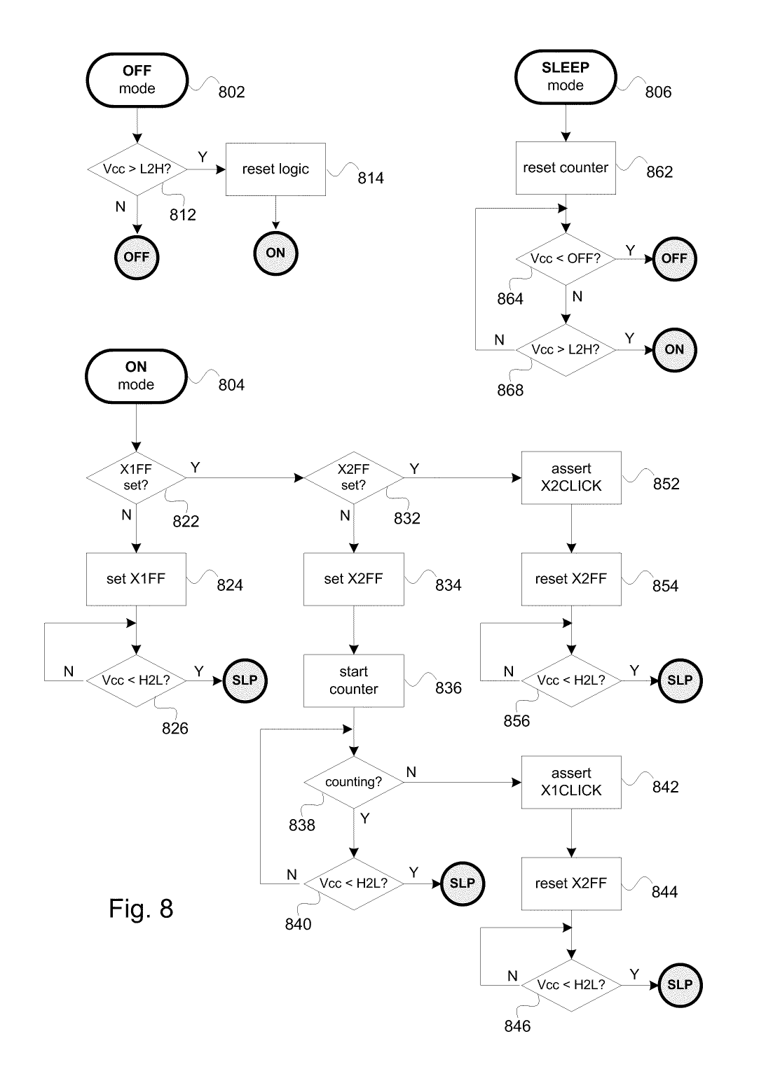

In embodiments, the logic circuit 202 can process the toggling actions described above in FIGS. 5-7 in accordance with the sequence diagrams shown in FIG. 8. Three modes of sequencing are illustrated: an OFF mode sequence 802, an ON mode sequence 804, and a SLEEP mode sequence 806. The circle-shaped symbols with OFF, ON, and SLP are connectors, respectively, to the OFF mode, ON mode, and SLEEP mode sequences 802, 804, 806. The OFF mode sequence 802 does not represent actual work that is performed by the logic circuit 202; rather it simply represents whether the power is being provided to the logic circuitry or not.

When the logic circuit 202 is turned off (i.e., power off condition), the OFF mode sequence 802 dictates. The logic circuit 202 remains turned off so long as V_{cc}<V_{L2H} (step 812), and thus the sequence remains in the OFF mode sequence 802. When V_{cc}>V_{L2H}, then the logic circuit 202 powers up and resets (step 814). For example, flips flops 412, 414 are reset, namely their respective outputs Q1, Q2 are LO. The counter 416 is also in the reset state, namely C₁ is LO. Sequencing in the logic circuit 202 then proceeds to the ON mode sequence 804.

In step 822, if the flip flop 412 (X1FF) is not set (as in the case when the logic circuit 202 is first turned on), then the flip flop 412 (X1FF) becomes set (step 824). The logic circuit 202 remains turned on so long as V_{cc}>V_{H2L} (step 826), namely the switch 104 remains in the ON position. If V_{cc}<V_{H2L} (e.g., the switch 104 was toggled to the OFF position), then sequencing in the logic circuit 202 proceeds to the SLEEP mode sequence 806.

Because the switch 104 is open, V_{cc} will fall and when its level falls below V_{H2L} (power save condition), then the counter 416 will reset (step 862). V_{cc} will continue to fall as power in the logic circuit 202 continues to dissipate. Sequencing will continue in the loop 864, 866 for a period of time after the switch 104 is open. If V_{cc} falls below V_{OFF} (step 864), then the logic circuit 202 will have lost power and sequencing of the logic circuit will proceed with OFF mode sequencing 802. If V_{cc} rises above V_{L2H} (step 866), i.e., when the switch 104 is closed before V_{cc} falls below V_{OFF}, then a toggle event is deemed to have occurred. The logic circuit 202 resumes sequencing in the ON mode sequence 804.

The decision at step 822 will evaluate to Y because the flip flop 412 (X1FF) remains set. However, step 832 will evaluate to N because the flip flop 414 (X2FF) is in the reset state. In step 834, the flip flop 414 (X2FF) is set. In step 836, the counter 416 is started. Sequencing will continue in the loop 838, 840.

If counting has completed (step 838), this means that a second toggle event was not detected in the time that the counter 416 was counting. In this way, the counter 416 can serve as a timer for determining whether a double toggle event has occurred or not. Since the counting has completed without detecting a second toggle action, the X1CLICK signal is asserted (step 842). The flip flop 414 is reset (step 844). Sequencing in the logic circuit 202 cycles through step 846 as long as V_{cc}>V_{H2L}; i.e., the switch remains closed. Otherwise, sequencing proceeds in the SLEEP mode sequence 806 if V_{cc}<V_{H2L}.

Returning to step 838, if the counting has not completed and if V_{cc} falls below V_{H2L} (step 840), then sequencing of the logic circuit 202 continues in the SLEEP mode sequence 806. The counter 416 is reset (step 862). In the manner discussed above, sequencing will continue in the loop 864, 866 for a period of time after the switch 104 is open. If V_{cc} falls below V_{OFF} (step 864), then the logic circuit 202 will enter the OFF state 302 and sequencing will proceed with OFF mode sequencing 802. If V_{cc} rises above V_{L2H} (step 866), i.e., when the switch 104 is closed before V_{cc} falls below V_{OFF}, then another toggle event has occurred. The logic circuit 202 resumes sequencing in the ON mode sequence 804.

The decision at step 822 will evaluate to Y because the flip flop 412 (X1FF) remains set, and likewise the decision at step 832 will also evaluate to Y because the flip flop 414 (X2FF) remains set. Both flip flops 412, 414 being set at this time signifies the occurrence of a double toggle action event. Accordingly, the X2CLICK signal is asserted (step 852). The flip flop 414 (X2FF) is reset (step 854). Sequencing in the logic circuit 202 cycles through step 846 so long as V_{cc}>V_{H2L}; i.e., the switch remains closed. Otherwise, sequencing proceeds in the SLEEP mode sequence 806 if V_{cc}<V_{H2L}.

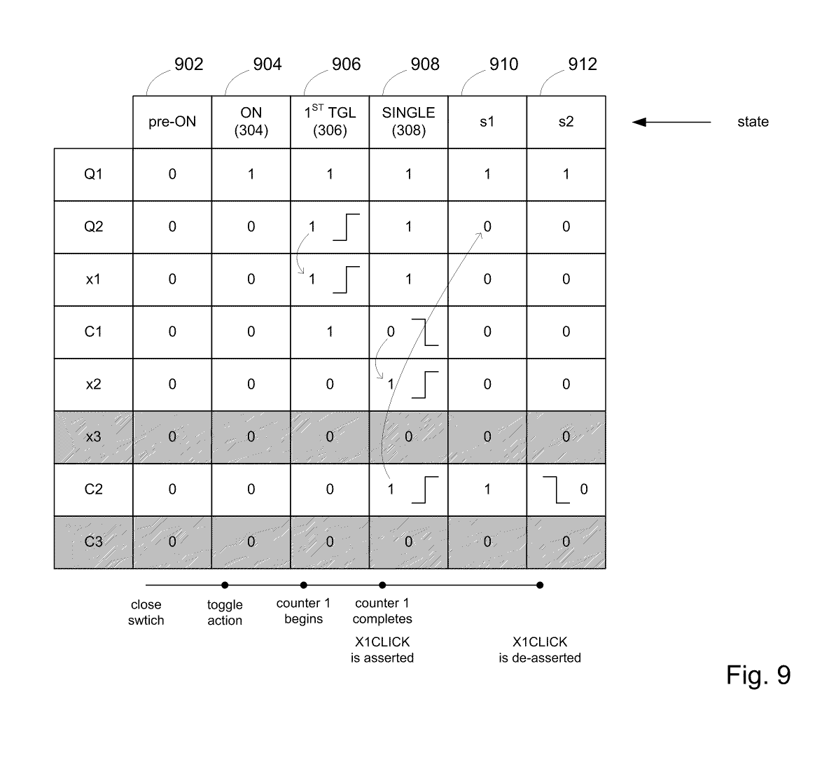

FIG. 9 represents a truth table for the inputs and outputs of the logic circuit 202, showing how the outputs vary as the state of the logic circuit changes (FIG. 3) for a SINGLE toggle event. As explained above, various devices that comprise the logic circuit 202 are clocked. Accordingly, the transition from one state to the next occurs when a trigger signal clocks one or more of the devices. In an embodiment, V_{cc} can be used as V_{trig}. Other signals are also used as a trigger, as will be explained below.

Initial state 902 represents an intermediate state between the OFF state 302 (no power) and the ON state 304, where V_{cc} is just turning on the devices of the logic circuit 202. Accordingly, all the devices are in reset and the outputs are LO. In this state, the S input of flip flop 412 is HI by virtue of the inverter 432. Accordingly, when V_{trig} comes along, the flip flop 412 will be set (step 824). The logic circuit 202 moves to the next state 904.

In state 904, the logic circuit 202 is in the ON state, and will remain in this state. Suppose the switch 104 is toggled off and then toggled on within the period of time t_{off}; i.e., a toggle event. The ‘toggle on’ segment of the toggle event will create a rising edge in V_{cc} (FIG. 6). Flip flops 412 and 414 are respectively set and reset (steps 822, 832). By virtue of AND gate 434, flip flop 414 will be set when V_{trig} comes along. The rising edge of Q2 as the flip flop 414 becomes set will create a rising edge in the output x1 of AND gate 438. This in turn will start the counter 416 (step 836), as we move into state 906; the count signal C₁ goes HI.

In state 906, the counter 416 continues counting. When the counter 416 completes, its count signal C₁ goes LO, moving the logic circuit 202 into state 908). The Hi to LO transition of C₁ creates a rising edge on the output of AND gate 440, which in turn will trigger the one-shot 422, thus asserting the X1CLICK signal C₂ (step 842).

The C₂ signal also serves as a trigger input to flip flop 414 via OR gate 436. At this point, the S input to flip flop 414 is LO, so when C₂ triggers the flip flop, the flip flop resets (step 844), moving us to intermediate state 910. When the one-shot 422 resets, its output C₂ returns to LO, and so the X1CLICK signal is de-asserted. The resulting state 912 is the same as the ON state 904.

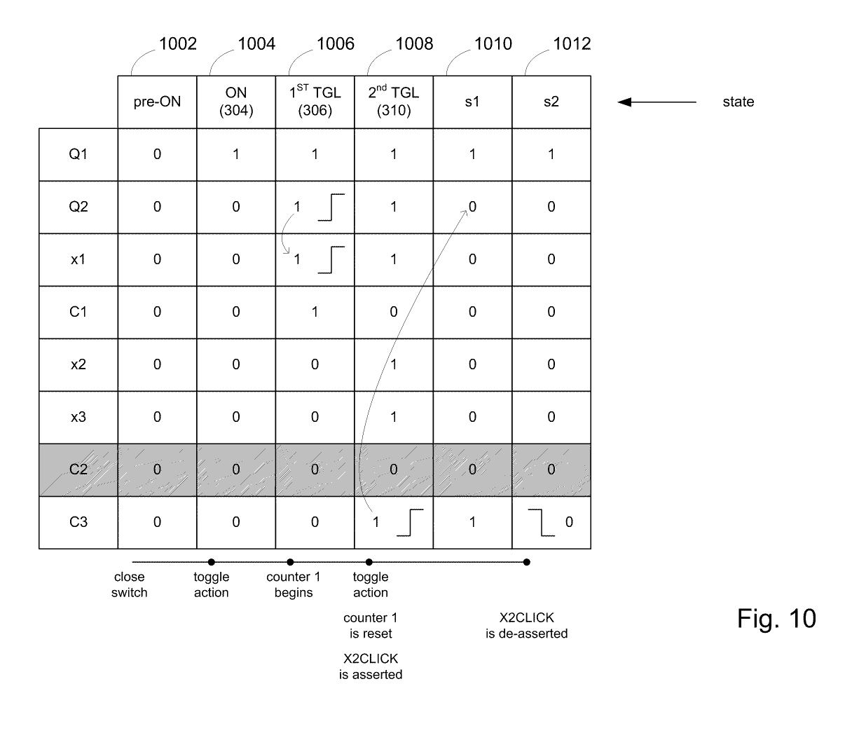

FIG. 10 represents a truth table for the inputs and outputs of the logic circuit 202, showing how the outputs vary as the state of the logic circuit changes (FIG. 3) for a DOUBLE toggle event. States 1002, 1004, and 1006 are identical to FIG. 9.

Consider state 1006 where counter 416 is counting. Suppose a second toggle event occurs before the counter 416 completes (step 840). As explained above, when the logic circuit 202 enters the power save condition counter 416 is reset. When the logic circuit 202 enters the power on condition, the xl signal will already be HI by virtue of Q1 and Q2 being HI. Accordingly, there is no rising edge on xl and so the counter 416 does not begin counting. Similarly, C₁ comes up in the reset state, so there is no transition from HI to LO. Accordingly, signal x2 does not transition from LO to HI, signal x2 simply comes up HI and so one-shot 422 does not trigger.

On the other hand, when V_{trig} comes along, the output x3 of AND gate 442 will transition from LO to HI, and trigger the one-shot 424, thus asserting X2CLICK (step 852) and moving the logic circuit 202 into state 1008. At this point, the S input to flip flop 414 is LO, so when C₃ triggers the flip flop, the flip flop resets (step 854), moving us to intermediate state 1010. When the one-shot 424 resets, its output C₃ returns to LO, and so the X2CLICK signal is de-asserted. The resulting state 1012 is the same as the ON state 1004.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method for controlling a device connected to a power switch, the power switch having an ON position and an OFF position to respectively provide power to the device and to interrupt power to the device, the method comprising:
detecting a SINGLE TOGGLE event comprising two toggle actions performed on the power switch within a first period of time;
performing a first action in response to detecting the SINGLE TOGGLE event;
detecting a DOUBLE TOGGLE event comprising a sequence of two or more SINGLE TOGGLE events; and
performing a second action different from the first action in response to detecting the DOUBLE TOGGLE event.

2. The method of claim 1, wherein the first action is asserting a first signal indicative of the SINGLE TOGGLE event, and the second action is asserting a second signal indicative of the DOUBLE TOGGLE event.

3. The method of claim 1, wherein the first action includes causing the device to perform a first function and the second action includes causing the device to perform a second function different from the first function.

4. The method of claim 1 further comprising controlling a power controller to provide a first function and a second when the SINGLE TOGGLE event and the DOUBLE TOGGLE event are respectively detected.

5. The method of claim 1, wherein the DOUBLE TOGGLE event comprises a first SINGLE TOGGLE event followed by a second SINGLE TOGGLE event.

6. The method of claim 5, wherein the first SINGLE TOGGLE event is separated from the second SINGLE TOGGLE event by a second period of time.

7. The method of claim 5, wherein the second period of time is based on a counter.

8. The method of claim 1, wherein the first period of time is based on a decay time of a logic circuit.

9. The method of claim 1, wherein the power switch is a single-pole single-throw type of switch.

10. An apparatus for sensing toggling in a power switch of an electric device to control the electronic device, the apparatus comprising:
means for detecting a toggle event of the power switch comprising a first toggle action followed by a second toggle action;
timing means for indicating whether a first toggle event of the power switch and a second event of the power switch occur within a given amount of time;
first asserting means for indicating that a SINGLE TOGGLE event has occurred; and
second asserting means for indicating that DOUBLE TOGGLE event has occurred.

11. The apparatus of claim 10 further comprising a power controller, the power controller performing a first function when the SINGLE TOGGLE event has occurred and a second function when the DOUBLE TOGGLE event has occurred.

12. The apparatus of claim 10, wherein the means for detecting a toggle event comprise a first storage element and a second storage element.

13. The apparatus of claim 10, wherein the first and second storage elements are first and second flip flops respectively.

14. The apparatus of claim 10, wherein the DOUBLE TOGGLE event comprises a first SINGLE TOGGLE event followed by a second SINGLE TOGGLE event.

15. The apparatus of claim 10, wherein the timing means includes a counter.

16. An electric device comprising:
a power switch;
a power controller to provide power to the electric device; and
a toggle detection circuit connected to the power switch, the toggle detection circuit outputting a first signal and a second signal,
the toggle detection circuit configured to detect an occurrence of a SINGLE TOGGLE event in the power switch and to output the first signal when the SINGLE TOGGLE event is detected,
the toggle detection circuit configured to detect an occurrence of a DOUBLE TOGGLE event in the power switch and to output the second signal when the DOUBLE TOGGLE event is detected,
the power controller performing a first power control function when the first signal is outputted,
the power controller performing a second power control function when the second signal is outputted,
wherein a DOUBLE TOGGLE event is a sequence of a first SINGLE TOGGLE event followed by a second SINGLE TOGGLE event.

17. The electric device of claim 16, wherein the DOUBLE TOGGLE event occurs when the first SINGLE TOGGLE event is followed by the second SINGLE TOGGLE event within a given period of time.

18. The electric device of claim 16, wherein the toggle detection circuit comprises:
means for detecting a toggle event of the power switch comprising a first toggle action followed by a second toggle action; and
timing means for indicating whether a first toggle event of the power switch and a second event of the power switch occur within a given amount of time.
